(19) United States
(12) Patent Application Publication
(10) Pub. No.: US 2005/0229497 A1
(43) Pub. Date: Oct. 20, 2005

(54) Process for controlling an adjusting drive for an electrically operated motor vehicle window with jamming protection

(75) Inventor: Matthias Eichin, Heilbronn (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c. F. Porsche Aktiengesellschaft, Stuttgart (DE)

(21) Appl. No.: 11/099,463

(22) Filed: Apr. 6, 2005

(30) Foreign Application Priority Data
Apr. 16, 2004 (DE) 102004018610.3

(51) Int. Cl. E05F 11/48

(52) U.S. Cl. 49/506

(57) ABSTRACT

A method of controlling an adjusting drive having a squeeze-in protection for electrically actuated window panes in motor vehicles, having an operating element for controlling the adjusting drive and a squeeze-in protection. The range of motion when lifting the window pane is divided into a first range (B1) and a second range (B2). In the first range (B1), the window pane is manually controlled during its lifting motion, so that the operating element must be operated for the lifting motion. When the operating element is released, the window pane (11) the lifting motion is stopped. In the second range (B2), the lifting motion of the window pane (11) is automatically implemented after a brief operation of the operating element.

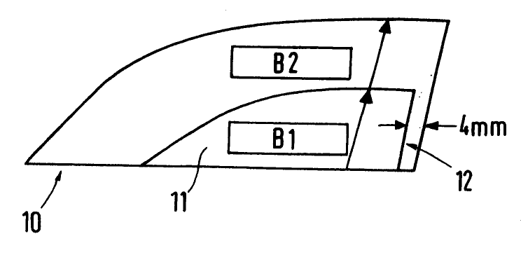

This application claims the priority of 10 2004 018 610.3, filed Apr. 16, 2004, the disclosure of which is expressly incorporated by reference herein.

### BACKGROUND AND SUMMARY OF THE INVENTION

The invention is based on an adjusting drive having a squeeze protection for movable parts, as known, for example, from International Patent Document WO 97/32102.

In the case of this known adjusting drive, the movable part, such as a window or sliding roof, is moved by means of a driving motor into a closed position by way of a squeeze danger area, in which foreign bodies can be squeezed between the movable part and a resting part. For avoiding the squeezing-in, the rate of motion is reduced in steps as a function of whether or not the moved part is in a squeeze danger range. The reduction of the rate of motion is implemented by the lowering of the rotational speed of the drive corresponding to a defined functional interrelationship between the danger area and a reduced-danger area.

The method according to the invention for controlling electrically operable window panes has the advantage that, as a result of dividing the motion of the window pane during the lifting into a first range, in which an automatic run of the window pane is not permitted, and into a second range, in which an automatic run is permitted, the danger of a squeezing-in is reduced even further. This division into different ranges is the result of the pane geometry and, in the case of vehicles whose window pane, because of the pane geometry, does not travel along the seal of the B-column when moved, has the advantage that, during the motion of the window pane, the squeezing-in of an obstacle between the pane edge and the B-column is prevented.

This motion control is advantageous particularly in the case of vehicles with frameless panes, such as coupes. Because of their geometry, these panes do not move directly along the B-column during the lifting and lowering. The lowering or lifting motion is, on the contrary, combined with a simultaneous sideways motion. During the lifting motion in a first motion section, this sideways movement causes a closing gap between the side edge of the window pane and the B-column, which in the following will be called a shearing gap.

The controlling of the side pane for the lifting according to the invention has the advantage that only a manual closing is permitted in a first range of the motion of the vehicle pane and, only after a second defined motion range has been reached, will the pane automatically move into a closed position after the operating element is actuated once. This has the advantage that, in the event of an accidental squeezing into the shearing gap, the motion of the window pane is stopped immediate when the operating element is released.

This solution also has the advantage that the manual controlling as well as the automatic run of the window pane can be implemented by means of an operating element for controlling the window pane motion.

Other objects, advantages and novel features of the present invention will become apparent from the following detailed description of the invention when considered in conjunction with the accompanying drawings.

### BRIEF DESCRIPTION OF THE DRAWING

The single FIGURE shows the cutout of a vehicle door with a side pane, in which case the different motion ranges of the side pane are illustrated.

### DETAILED DESCRIPTION OF THE DRAWING

In the FIGURE, reference number 10 illustrates the window cutout of a vehicle door which is closed by a window pane 11. Reference number 12 shows a shearing gap which is created during the motion of the window pane 11. The motion of the side pane is divided into two ranges B1 and B2, the division of the panes resulting from the width of the shearing gap. As a result of the motion and the pane geometry, a distribution of forces is obtained such during the motion of a window pane that the squeezing-in forces occurring in a shearing gap are significantly larger than the squeezing-in forces which occur as a result of the vertical motion of the pane between the horizontal upper edge of the window pane and the roof edge of the vehicle.

A first range B1 is thereby defined in which the occurring shearing gap 12 represents an increased squeezing-in risk. The squeezing-in risk is increased when a closing gap is larger than 4 mm. Therefore, in the embodiment, the first range B1 is defined as the range in which the shearing gap 12 is larger than 4 mm. In this first range B1, the lifting motion can be take place only directly by way of a manual control; that is, the person who wants to close the window pane 11 has to continuously operate the operating element. When the operating element is released, the pane will stop immediately.

If the shearing gap falls below the definable size of 4 mm, the risk that, for example, a hand may be squeezed in will no longer exist, and this range is defined as the second range B2.

If the window pane moves into range B2 and the operating switch is still depressed, the run of the window pane changes to the automatic run and the operating switch can be released. The pane closes automatically and can, for example, be stopped only by another operation of the operating element.

The definition and determination of the individual ranges B1 and B2 is a result of the pane construction and is determined during the construction and filed in the window lifter control unit.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method of controlling an adjusting drive for electrically actuated window panes in motor vehicles, said method comprising the steps:
dividing a range of motion when lifting the window pane from an open position toward a closed position into a first range (B1) and a second range (B2);
manually controlling said lifting when said window pane is in said first range, whereby the operating element must be operated for the lifting motion, and when the operating element is released, the lifting of window pane is stopped; and
automatically implementing the lifting motion of the window pane after a brief operation of the operating element when said window pane is in said second range.

2. Method according to claim 1, wherein
the first range of the lifting motion of the window pane is defined by the size of a shearing gap which occurs between a side edge of the window pane and a B-column of the motor vehicle.

3. Adjusting drive according to claim 2, wherein
the first range is defined as a section of the motion of the window pane in which the shearing gap is larger than 4 mm.

4. A method of controlling movement of a motor vehicle window, comprising the steps:
controlling a first movement of said window from a first position to a second position by continuous activation of an operation element; and
providing automatic second movement of said window from said second position to a third position by a brief activation of said operating element.

5. The method of claim 4, wherein
said second position is defined by a predetermined shearing gap between said window and a column of said automobile.

6. The method of claim 4, wherein
said third position is a closed position of said window, and
said first position is a fully open position of said window.
